(19) United States
(12) Patent Application Publication
(10) Pub. No.: US 2010/0242695 A1
(43) Pub. Date: Sep. 30, 2010

(54) Optical marking mechanism and method for marking lines for a power tool

(76) Inventors: Kesong Xu, Nanjing (CN); Lijun Ma, Nanjing (CN); Bing Wu, Nanjing (CN); Ming Chen, Nanjing (CN)

Correspondence Address: MCDERMOTT, WILL & EMERY LLP;Attn: IP Department, 227 WEST MONROE STREET, SUITE 4400, CHICAGO, IL, 60606-5096, US

(21) Appl. No.: 12/661,667

(22) Filed: Mar. 22, 2010

(30) Foreign Application Priority Data
Mar. 30, 2009 (CN) CN 200910029646.1

(51) Int. Cl. B26D 7/00

(52) U.S. Cl. 83/13; 83/520

(57) ABSTRACT

An optical marking mechanism for a power tool, the power tool comprising a cutting blade with a cutting width. The optical marking mechanism comprising a light source emitting a first light beam and an optical element located on the end of the emitting light for converting the first light beam into a planar light beam. The planar light beam being able to assist a user in incorporating the cutting width of the cutting blade when cutting a workpiece to increase the measurement accuracy of the resultant cut workpiece.

### CROSS-REFERENCE TO RELATED APPLICATIONS

This application claims priority under 35 U.S.C. §119 to CN 200910029646.1 filed Mar. 30, 2009, which is hereby incorporated by reference.

### FEDERALLY SPONSORED RESEARCH OR DEVELOPMENT

Not Applicable.

### TECHNICAL FIELD

The present invention relates to an optical marking mechanism for a power tool and a method for marking lines.

### BACKGROUND OF THE INVENTION

In the prior art, an optical marking mechanism on a power tool is widely used, particularly on a power tool used for cutting. Specifically, a laser marking mechanism is normally used as the optical marking mechanism. The laser marking mechanism generally comprises a laser module with a laser diode. The laser module emits a sector laser beam which forms a laser indicating line on a workpiece. The laser marking mechanism can be designed to make the sector laser beam align with an outer edge or a central plane of a cutting blade. As a result, when the laser indicating line is aligned with a predetermined cutting line on the workpiece, it ensures that the edge or the central plane of the cutting blade aligns with the predetermined cutting line. This allows a user to easily move the cutting blade along the predetermined cutting line.

In the prior art described above, the laser marking mechanism can only project a single indicating line, which does not always satisfy the user's requirements.

When the laser marking mechanism is designed to align the sector laser beam with an outer edge of the cutting blade, the laser indicating line on the workpiece only indicates the cutting position of one side of the cutting blade. However, the cutting blade has a width. Because of the width, when the user feeds the workpiece from both sides of the cutting blade, the resultant cutting length of the workpiece fed from the left side is not equal to the resultant cutting length of the workpiece fed from the right side of the cutting blade. Accordingly, the single-line marking mechanism limits the two-side feeding operation.

When the laser marking mechanism is designed to align the laser beam with the central plane of the cutting blade and allow the laser indicating line to indicate the two outer edges of the cutting blade, the width of the laser indicating line on the workpiece is equal to the width of the cutting blade. However, because a cutting blade with a different width may be used in a power tool, depending on the desired use, it is desired that the width of the laser indicating line be adjustable to adapt to the different widths of the cutting blade. This sort of adjustment may be difficult for a user to implement accurately.

### SUMMARY OF THE INVENTION

An object of the invention is to provide an optical marking mechanism for a power tool, the power tool having a cutting blade with a cutting width. The optical marking mechanism has a light source to emit a first light beam and an optical element for converting the first light beam into a planar light beam. The optical element may be located on the emitting end of the light source and a light blocking means may be located on a light path of the light source and the optical element.

The invention also describes a method for marking lines using an optical marking mechanism for a power tool. The method includes providing a light blocking means on a light path of a light source and an optical element. These make a laser module project two parallel planar laser beams on a workpiece to form two parallel laser indicating lines. Each of the two laser indicating lines has two sides and a distance is formed between the two sides that are adjacent to each other.

In the present invention, the light blocking means may be located in the light path of the light source and the optical element. Preferably, the light source comprises a laser module. The light blocking means blocks a part of the light beam. The light blocking means may be arranged in the middle of the light beam so as to divide the light beam into two parts, which makes the two laser indicating lines formed on the workpiece have a distance therebetween. When the laser marking mechanism is used with a power tool, such as a circular saw or a miter saw, the projection of the light blocking mechanism formed on the optical element has a width which is equal to the cutting width of the cutting blade. During operation, a user only needs to align one side of the cutting blade with the predetermined cutting line on the workpiece. The user may then feed the workpiece from either side of the cutting blade and the resultant cutting length of the workpiece is the same regardless of which side is used.

### BRIEF DESCRIPTION OF THE DRAWINGS

The present invention will become apparent from the following detailed description of the preferred embodiment of the invention illustrated in the accompanying drawings, wherein:

FIG. 1a is a perspective view of a laser marking mechanism of a first embodiment according to the present invention;

FIG. 1b is a sectional view along A-A in FIG. 1a;

FIG. 1c is an exploded view of the laser marking mechanism in FIG. 1a;

FIG. 1d is a perspective view showing a light path of the laser marking mechanism in FIG. 1a;

FIG. 2 is a perspective view of a power tool with the laser marking mechanism in FIG. 1a;

FIG. 3a is a perspective view of a laser marking mechanism of a second embodiment according to the present invention;

FIG. 3b is a right view of the laser marking mechanism in FIG. 3a;

FIG. 3c is a perspective view showing a light path of the laser marking mechanism in FIG. 3a;

FIG. 4a is a perspective view of a laser marking mechanism of a third embodiment according to the present invention;

FIG. 4b is a perspective view of a corrugated lens in FIG. 4a;

FIG. 5 is a perspective view of a laser marking mechanism of a fourth embodiment according to the present invention; and,

FIG. 6 is an exploded view of the laser marking mechanism in FIG. 5.

### DETAILED DESCRIPTION

### First Embodiment

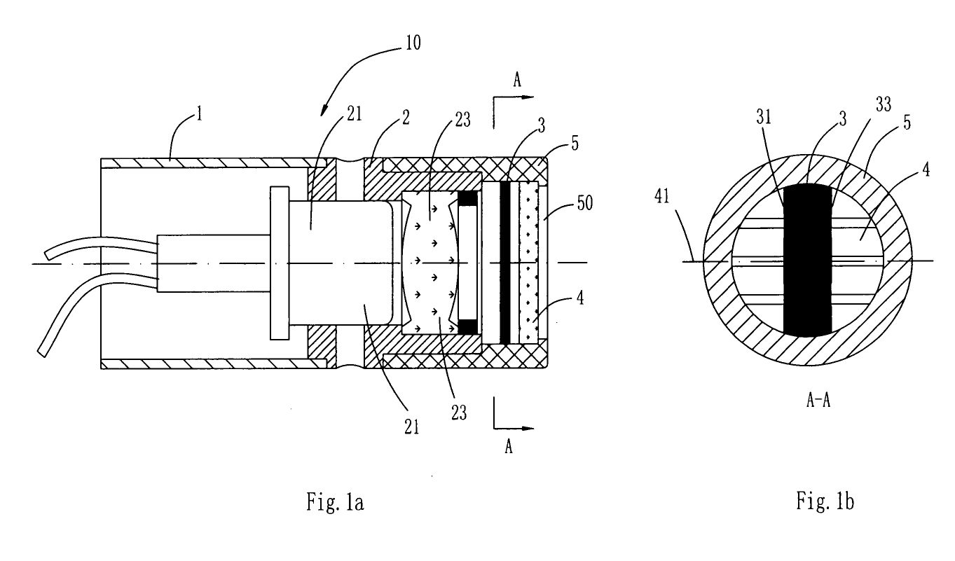

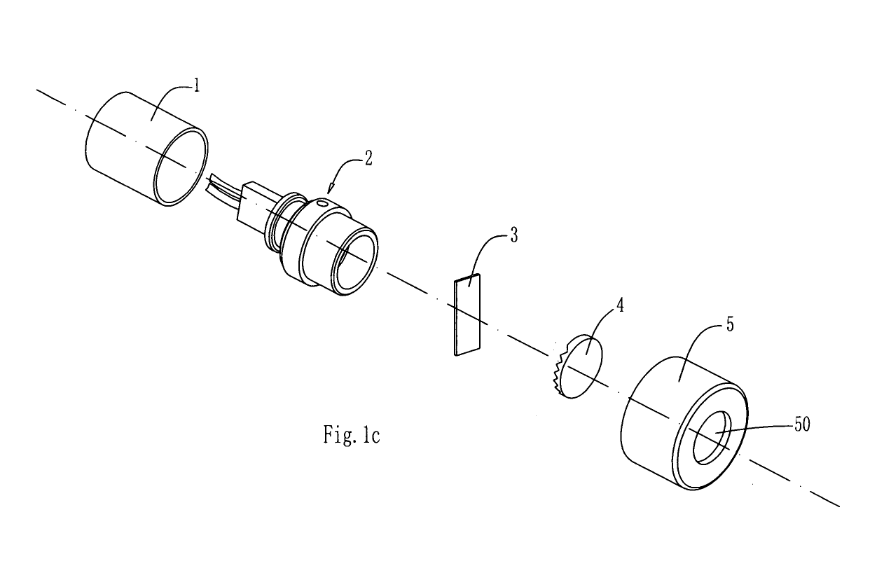

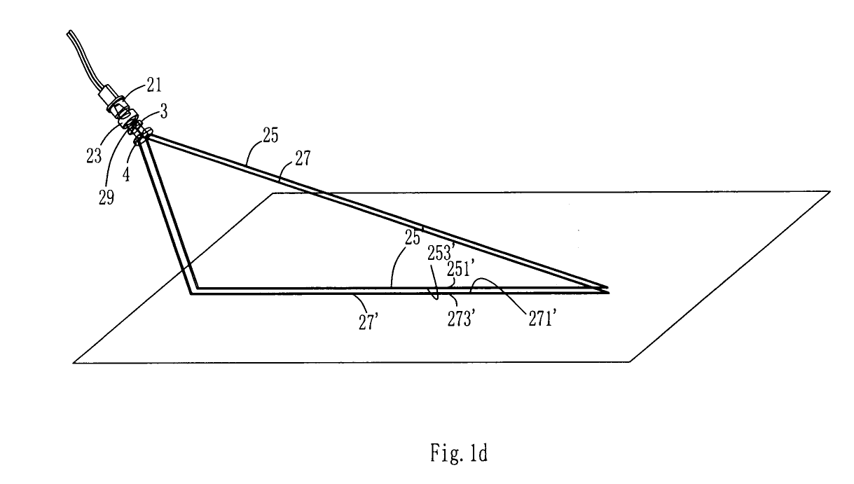

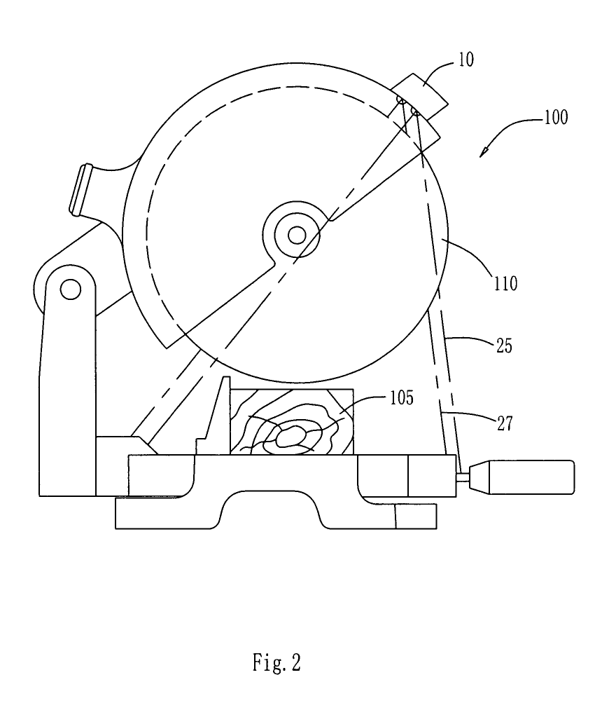

FIGS. 1a to 2 show a laser marking mechanism 10 of a first embodiment. The laser marking mechanism 10 comprises a housing 1, a laser module 2, a diaphragm 3 and a corrugated lens 4. The housing 1 covers the wire end of the laser module 2 to avoid the wire end being exposed and damaged. Those skilled in the art may appreciate that the laser module 2 comprises a laser diode 21 and a convex lens or a lens group 23. A laser beam emitted by the laser diode 21 passes through the convex lens 23 and then forms a straight laser beam 29.

The diaphragm 3 is located between the laser module 2 and the corrugated lens 4. A cover 5 covers the corrugated lens 4 and a part of the laser module 2. The cover 5 is provided with a hole 50 to allow the laser beam from the corrugated lens 4 to pass through. With reference to FIG. 1b, the diaphragm 3 is elongated and located in the horizontal middle relative to the longitudinal direction of the corrugations of the corrugated lens 4. The corrugated lens 4 has a plurality of corrugations which are parallel with each other. A central line 41 is parallel with the corrugations and is located in the middle of the corrugated lens 4. A projection of the diaphragm 3 formed on the corrugated lens 4 has two sides 31, 33 which are parallel with each other and perpendicular to the central line 41. The laser beam emitted by the laser module 2 is wider than the projection of the diaphragm 3. When the laser beam passes the diaphragm 3, the middle part of the laser beam is blocked by the diaphragm 3, and the rest laser beam which is not blocked by the diaphragm 3 is received by the corrugated lens 4. Thus, two parallel sector laser beams 25, 27 are formed. As a result, the two parallel sector laser beams 25, 27 project on a workpiece to produce two parallel laser indicating lines 25′, 27′. With reference to FIG. 1d, each sector laser beam has two sides 251′, 253′ and 271′, 273′. Wherein, the two sides 253′, 271′ which are adjacent to each other have a distance therebetween.

Alternatively, in another embodiment, the diaphragm 3 may be located on the outside of the corrugated lens 4 on the surface opposite from the surface nearest the laser module 2. Or explaining it another way, the diaphragm 3 may be located between the corrugated lens 4 and the cover 5. As a result, the laser beam emitted by the laser module 2 passes through the corrugated lens 4 and forms a wider planar laser beam. The planar laser beam is then divided into two parallel sector laser beams because the middle part of the laser beam is blocked by the diaphragm 3. Finally, the two parallel sector laser beams project on the workpiece and form two parallel laser indicating lines. Alternatively, the diaphragm may be located or formed on an alternate side of the corrugated lens or a side of the convex lens, as long as the diaphragm is opaque, such as a light proof film.

The laser marking mechanism 10 of the first embodiment can be used on many different power tools, such as a circular saw, a miter saw, etc. With reference to FIG. 2, the laser marking mechanism 10 is mounted on a miter saw 100 through a fixing means for projecting two parallel laser indicating lines 25′, 27′ on a workpiece 105. The miter saw 100 comprises a cutting blade 110 with a cutting width. Preferably, the width of the projection of the diaphragm 3 formed on the corrugated lens 4 is designed to be equal to the cutting width. As a result, the distance between the two adjacent sides 253′, 271′ is equal to the cutting width of the cutting blade. This allows the user to easily recognize the cutting position and cutting width on the workpiece. As a result, the resultant cutting length is accurate regardless of which side the workpiece is fed to the cutting blade.

### Second Embodiment

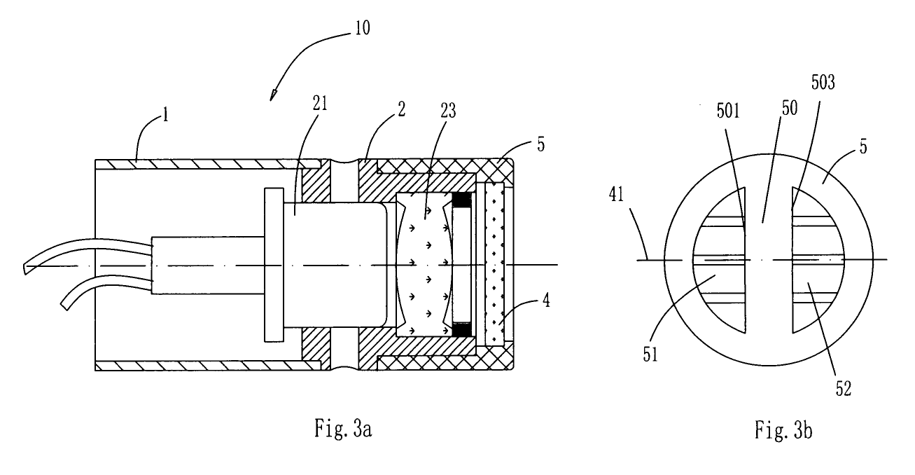

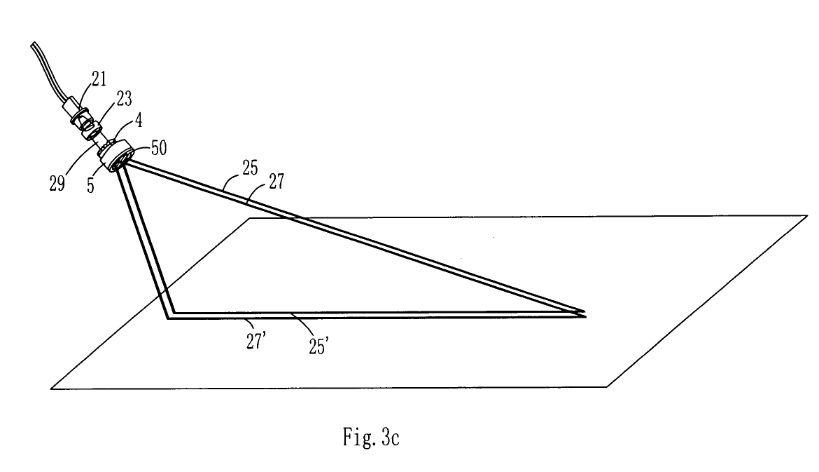

FIGS. 3a and 3b show the laser marking mechanism 10 of a second embodiment. The same reference numerals denote the same parts in the first embodiment. However, in the second embodiment, there is not a single diaphragm. The laser beam emitted by the laser module irradiates directly on the corrugated lens 4. As shown in FIG. 3b, the cover 5 is provided with two half-circular holes 51, 52 with the same diameter. A vertical bar 50 is formed between the two half-circular holes 51, 52, which is integral with the cover 5 and acts as the diaphragm 3 in the first embodiment. A projection of the vertical bar 50 formed on the corrugated lens 4 has two sides 501, 502, which are parallel with each other and perpendicular to the central line 41. When the sector laser beam from the corrugated lens 4 passes the cover 5, the middle part is blocked by the vertical bar 50, and the resultant laser beam projects from the two half-circular holes 51, 52 and forms two parallel sector laser beams. Finally, the two parallel sector laser beams project on the workpiece and form two parallel laser indicating lines as shown in FIG. 3c.

The laser marking mechanism 10 of the second embodiment can also be used on many different power tools. When it is used on a cutting tool, such as a circular saw or a miter saw, the width of the vertical bar 50 of the cover 5 is designed to be equal to the cutting width of the cutting blade. With this structure, the two laser indicating lines on the workpiece show the cutting positions of the two sides of the cutting blade.

### Third Embodiment

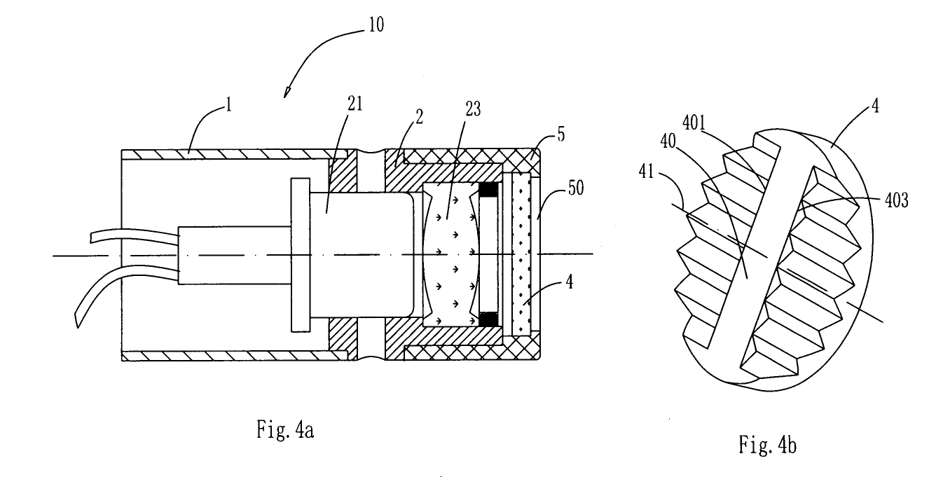

FIGS. 4a and 4b show the laser marking mechanism 10 of a third embodiment. The same reference numerals denote the same parts in the first and second embodiments. In the third embodiment, similar to the second embodiment, there is not a single diaphragm. The cover 5 is provided with a circular hole 50. As shown in FIG. 4b, the corrugated lens 4 on the surface nearest to the laser module 2 has a planar part 40 which is located in the middle thereof. The planar part 40 has two sides 401, 403 which are parallel with each other and perpendicular to the central line 41. When the laser beam emitted by the laser module 2 irradiates on the corrugated lens 4, the portion of the laser beam which irradiates on the planar part 40 is not spread out into the sector laser beam, and the rest part of the laser beam is refracted into two parallel sector laser beams. The two parallel sector laser beams project on the workpiece and form two parallel laser indicating lines.

Alternatively, in another embodiment, an opaque material may be used on the corrugated lens 4 so as to form a lightproof region which acts as the diaphragm.

The laser marking mechanism 10 of the third embodiment can be used on many different power tools. Preferably, the width of the planar part 40 of the corrugated lens 4 is designed to be equal to the cutting width of the cutting blade.

### Fourth Embodiment

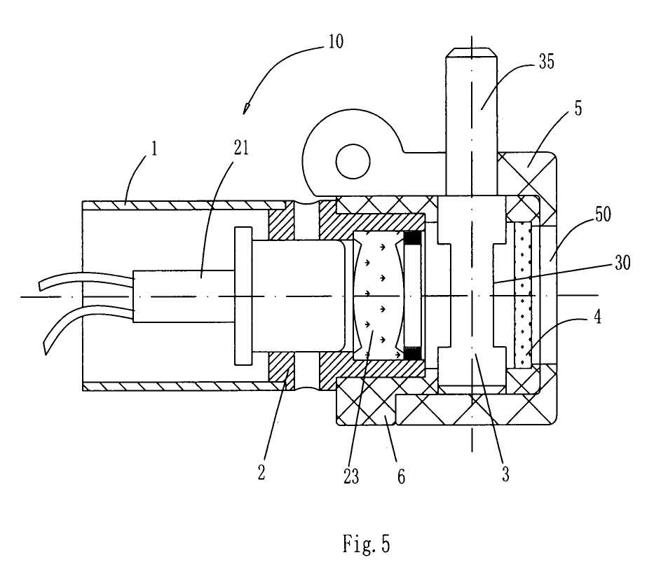

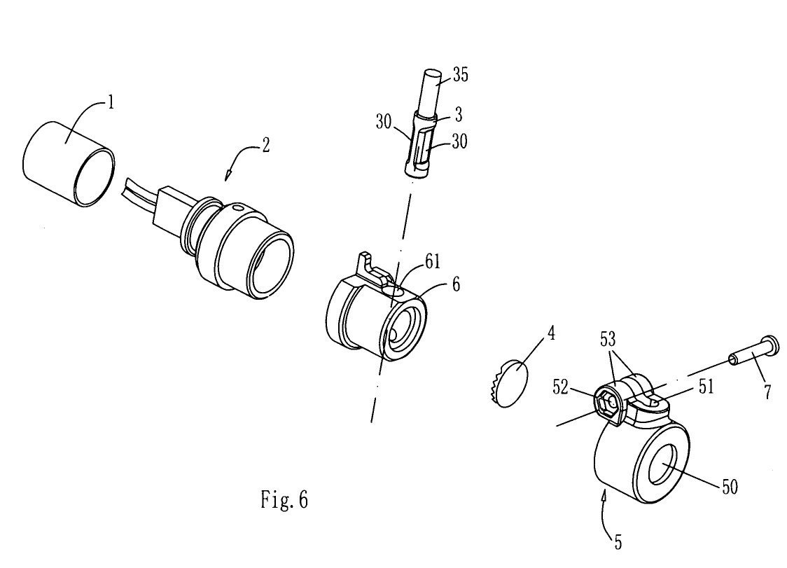

FIGS. 5 and 6 show the laser marking mechanism 10 of a fourth embodiment. The same reference numerals denote the same parts of the three embodiments described above. The fourth embodiment discloses an adjustable laser marking mechanism 10. The diaphragm 3 is a cylinder with a pole 35 fixed on its upper end. The diaphragm 3 is rotatably mounted in a diaphragm seat 6. The cover 5 couples with the diaphragm seat 6. The pole 35 extends out from a hole 61 of the diaphragm seat 6 and a hole 51 of the cover. The diaphragm 3 includes two recesses 30 which are opposite to each other in the radial direction. Thereby the diaphragm 3 has different sizes in the radial direction. When the recess 30 faces the laser module 2, the projection of the diaphragm 3 has the largest width. And when the recess 30 is perpendicular to the laser module 2, the projection has the smallest width. The width of the projection of the diaphragm 3 can be adjusted by rotating the pole 35. The cover includes two lugs 53, each of which has a screw hole 52. A bolt 7 is engaged with the screw holes 52. When the width of the projection of the diaphragm 3 is adjusted to the desired width, for example equal to the cutting width of the cutting blade, the bolt 7 is tightened to fix the position of the diaphragm 3. Alternatively, the diaphragm 3 may be flat or other suitable shapes.

Using the structure described above, the user can adjust the width of the projection of the diaphragm 3 formed on the corrugated lens 4 by rotating the pole 35. As a result, the distance between the two laser indicating lines on the workpiece varies with the change of the width of the projection of the diaphragm 3. Accordingly, when the laser marking mechanism 10 is used to a power tool, the user can adjust the diaphragm 3 according to the cutting width of the cutting blade. This allows one of the two sides of the two parallel laser beams that are adjacent to each other to be aligned with one side of the cutting blade and the other side of the two sides of the two parallel laser beams to be aligned with the other side of the cutting blade. As a result, the distance between the two indicating lines indicates the cutting width of the cutting blade.

The laser marking mechanism of the present invention is not limited to use with a power tool. The laser marking mechanism may be used with other machines that would benefit from a projection of two parallel lights or lines. Similarly, the light source is not limited to a laser module and other suitable light source may be adopted.

The present invention is not restricted as the embodiments disclosed hereinabove. For example, the corrugated lens may be replaced with other optical element which can convert a laser beam into a sector laser beam, such as a cylindrical lens or a cylindrical mirror. These optical elements have a longitudinal direction which is perpendicular to spreading direction of the sector laser beam. Preferably, the projection of the diaphragm has two sides which are perpendicular to the longitudinal direction of the optical element. Accordingly, any substitutes and modifications according to the spirit of the present invention will be regarded as falling within the claims appended hereto.

What is claimed is:

1. An optical marking mechanism for a power tool, the power tool comprising a cutting blade with a cutting width, the optical marking mechanism comprising:
a light source emitting a first light beam;
an optical element for converting the first light beam into a planar light beam, the optical element being located on an emitting end of the light source; and
a light blocking means located in a light path of the light source and the optical element.

2. The optical marking mechanism of claim 1, wherein the light source is a laser module.

3. The optical marking mechanism of claim 2, wherein the laser module comprises a laser diode and a lens for converting the laser beam emitted by the laser diode into a straight laser beam.

4. The optical marking mechanism of claim 1, wherein the light blocking means is located at a location, the location being at least one of between the light source and the optical element and on the side of the optical element opposite the side nearest the light source.

5. The optical marking mechanism of claim 4, wherein the light blocking means has an elongated effective part.

6. The optical marking mechanism of claim 4, wherein the light blocking means is adjustably mounted on the light path, wherein when the light blocking means is adjusted, the width of a projection of the light blocking means formed on the optical element is changed.

7. The optical marking mechanism of claim 6, wherein the light blocking means is a rotatable cylinder, the cylinder having portions with different radiuses.

8. The optical marking mechanism of claim 4 comprising a cover for receiving the optical element, wherein the light blocking means is formed on one end of the cover.

9. The optical marking mechanism of claim 8, wherein the light blocking means is integral with the cover and the cover is provided with two half-circular holes with the same hole diameter, the light blocking means being formed between the two half-circular holes.

10. The optical marking mechanism of claim 4, wherein the first light beam is wider than a projection of the light blocking means formed on the optical element.

11. The optical marking mechanism of claim 4, wherein a projection of the light blocking means formed on the optical element has two sides which are parallel with each other.

12. The optical marking mechanism of claim 10, wherein the projection has two sides which are perpendicular to the longitudinal direction of the optical element.

13. The optical marking mechanism of claim 10, wherein the projection has a width which is equal to the cutting width of the cutting blade.

14. The optical marking mechanism of claim 1, wherein the light blocking means is located on one of the two sides of the optical element.

15. The optical marking mechanism of claim 14, wherein the light blocking means is an opaque film.

16. The optical marking mechanism of claim 14, wherein the first light beam is wider than the light blocking means.

17. The optical marking mechanism of claim 14, wherein the light blocking means has a width which is equal to the cutting width of the cutting blade.

18. The optical marking mechanism of claim 1, wherein the first light beam passing the optical element and the light blocking means is converted into two parallel light beams, the two parallel light beams forming two parallel indicating lines on a workpiece.

19. The optical marking mechanism of claim 18, wherein each indicating line has two sides, a distance formed between the two sides that are adjacent to each other is equal to the cutting width of the cutting blade.

20. The optical marking mechanism of claim 1, wherein the optical element is a corrugated lens.

21. The optical marking mechanism of claim 1, wherein the optical element is a cylindrical lens.

22. An optical marking mechanism for a power tool, the power tool comprising a cutting blade with a cutting width, the optical marking mechanism comprising:
a light source emitting a first light beam;
an optical element for converting the first light beam into a planar light beam, the optical element being located on the emitting end of the light source;
wherein the optical element is a lens, the lens having a first part which allows light to pass through without diverging.

23. The optical marking mechanism of claim 22, wherein the first part is a planar part.

24. A method for marking lines using an optical marking mechanism for a power tool, comprising:
providing a light blocking means on a light path of a light source and an optical element, which creates a laser module project two parallel planar laser beams;
projecting the two parallel laser beams on a workpiece to form two parallel laser indicating lines, each laser indicating line having two sides, a distance being formed between the two sides that are adjacent to each other.

25. The method for marking lines using an optical marking mechanism for a power tool of claim 24 comprising:
adjusting the light blocking means to make one of said two sides that are adjacent to each other align with a first side of a cutting blade, and make the other one of said two sides align with the second opposite side of the cutting blade.

26. The method for marking lines using an optical marking mechanism for a power tool of claim 24, wherein the light source is a laser module.

27. The method for marking lines using an optical marking mechanism for a power tool of claim 26, wherein the laser module comprises a laser diode and a lens for converting the laser beam emitted by the laser diode into a straight laser beam.

28. The method for marking lines using an optical marking mechanism for a power tool of claim 24, wherein the light blocking means is located at a location, the location being at least one of between the light source and the optical element and on the side of the optical element opposite the side nearest the light source.
